(19) United States
(12) Patent Application Publication
(10) Pub. No.: US 2002/0073165 A1
(43) Pub. Date: Jun. 13, 2002

(54) Real-time context-sensitive customization of user-requested content

(75) Inventors: Dale McNulty, Laguna Niguel, CA (US); Stuart Kerr, Long Beach, CA (US); Dale Egan, Oceanside, CA (US)

Correspondence Address: LYON & LYON LLP, 633 WEST FIFTH STREET, SUITE 4700, LOS ANGELES, CA, 90071, US

(73) Assignee: Pingpong Technology, Inc., Fountain Valley, CA (US)

(21) Appl. No.: 09/729,638

(22) Filed: Dec. 1, 2000

Related U.S. Application Data
(63) Continuation-in-part of application No. 09/694,642, filed on Oct. 23, 2000.

(51) Int. Cl. G06F 15/16

(52) U.S. Cl. 709/217

(57) ABSTRACT

A system and method for customized information design, archiving and presentation. More specifically, a context-sensitive retrieval system and method are described that retrieve content and action relevant to the information that the user has requested and present the additional content and action on a real-time basis to the user, or to the user and others, substantially simultaneously with the arrival of the originally requested information.

### RELATED APPLICATION INFORMATION

This application is a continuation-in-part of U.S. patent application Ser. No. 09/694,642 filed Oct. 23, 2000, entitled “Real-Time Context-Sensitive Customization of User Requested Content”, which application is hereby incorporated in its entirety by reference.

### COPYRIGHT NOTICE

A portion of the disclosure of this patent document contains material that is subject to copyright protection. The copyright owner has no objection to the xerographic reproduction by anyone of the patent document or the patent disclosure in exactly the form it appears in the Patent and Trademark Office patent file or records, but otherwise reserves all copyright rights whatsoever.

### FIELD OF THE INVENTION

The present invention relates generally to the field of customized information design, archiving, analysis and presentation. More specifically, one embodiment of the invention provides a context-sensitive retrieval system that retrieves content and invokes actions relevant to the information that the user has requested and presents the additional content and action to the user, or to the user and to others, substantially simultaneously with the originally requested information.

### BACKGROUND

Recently, a global network known as the Internet has attracted wide use. Using the network, a local computer, or “client,” can connect to a distant server and request a file or an image from the server. The server sends the file or image back to the client over the network.

One popular technology enjoying wide use with the Internet is known as the World Wide Web (“Web”). The name and location of each server connected to the Internet on the Web is indexed at several computers known as Domain Name Servers (DNSs). The Web enables a client to locate a remote server using the DNS, and then to connect to the remote computer and send and receive information (a Web “page”) using a communication protocol called the Hypertext Transfer Protocol (HTTP).

On the Web, a Uniform Resource Locator (URL) is a network address that uniquely identifies the location of each page of information or “content” stored on a remote server. The client sends a request containing the URL of the desired page to the appropriate remote server. The server receives the request, locates the page corresponding to the URL, and returns the page to the client over the network. The pages are generally files prepared in the Hypertext Markup Language (HTML). HTML provides basic document formatting and allows the developer to specify “links” to other servers and files. When a user activates one of these links, a request for the URL associated with the link is sent out over the Web.

The explosive growth of Web content, or pages of information, has contributed to an emerging problem for the Web user—the inability to find relevant Web content and services quickly and easily. Moreover, the user is typically presented with generic content that is not customized to the user's preferences.

Because users will continually demand more efficient, custom-tailored ways to work the Web, there exists a need for new models of customization and interaction that will enable individually-tailored content and services to be delivered to the user with minimal user intervention required. Moreover, there is a need for content options to be presented to the user in an easily understandable format that is responsive to the user's varying needs and where navigation to access the options is substantially intuitive.

### SUMMARY OF THE INVENTION

The present invention provides a system for customized information design and presentation.

One embodiment of the invention includes a computer-implemented system for the dynamic customization of user-requested content. The system includes a network-connected client that has a browser that sends a user request for a content item belonging to a category to the network and a customization server platform that is connected to the network and receives the request from the client. The server platform includes an information source that has the content item, an application program that specifies a taxonomy of the relationship of content items and actions based on their categories, and a rules and action module. The rules and action module has an action belonging to the category and a rule for invoking the action upon the identification of the receipt of a requested content item that has the same category as the action.

Another embodiment is a computer-implemented system for the dynamic customization of content to a user-specified persona. The system includes a network-connected client that has a browser that sends a user-specified persona belonging to a category to the network and a customization server platform that is connected to the network and receives the persona from the client. The server platform includes an information source for storing the persona, an application program that specifies a taxonomy of the relationship of personas and actions based on their categories, and a rules and action module. The rules and action module has an action belonging to the category and a rule for invoking the action upon the identification of the receipt of a persona having the same category as the action.

Another embodiment is a computer-implemented system for the dynamic auto-indexing and expansion of the content of an information source based on user-requested content. The system includes a network-connected client that has a browser that sends a user request for a content item belonging to a category to the network, and a customization server platform connected to the network that receives the request for the content item. The server platform includes a first information source that has the content item, an application program that specifies a taxonomy of the relationship of content items and actions based on their categories, and an information retrieval module. The information retrieval module includes a front-end application program for retrieving the content item and its linked category content from a second information source on the network and storing the retrieved content in the first information source.

Another embodiment is a computer-implemented system for the dynamic auto-updating of the content of an information source based on user-requested content. The system includes a network-connected client that has a browser that sends a user request for a content item to the network, and a customization server platform connected to the network that receives the request for the content item. The content item sent by the client has a second version indicator and belongs to a category. The server platform includes a first information source, an application program specifying a taxonomy of the relationship of content items and actions based on their categories, and an information retrieval module. The first information source has the content item requested by the user, however the content item has a first version indicator. The information retrieval module includes a front-end application program and a back end application program. The back-end application program has a means for comparing the version indicators of a requested content item with the version indicator of the content item stored in the first information source. The back-end application program sends a request for the URL of the content item when the version indicators do not match. The front-end application program receives the request for the URL and retrieves its second version content and linked content from a second information source connected to the network and stores the retrieved second version content item in the first information source. The second version of the content item is a version created subsequent to the creation of the first version of the content item.

Another embodiment is a method for implementing the dynamic customization of user-requested content. The method includes the step of providing a computer-implemented system that includes a network-connected client having a browser and a network-connected customization server platform. The customization server platform includes a taxonomy application program and a rules and action module that has an action and a rule for invoking the action upon the identification of the receipt of a request for a content item of the same category as the action from the client. The method further includes the steps of receiving a request at the server platform from the client for a categorized content item and identifying the category of the requested content item. The method then causes the rule in the rules and action module to invoke the action having the same category as the content item.

### BRIEF DESCRIPTION OF THE DRAWINGS

For a better understanding of the invention, and to show how it may be carried into effect, reference will be made, by way of example, to the accompanying drawings, in which:

FIG. 1 is a schematic view of an embodiment of a computer-implemented system for the dynamic customization of user-requested content.

FIG. 2 is a schematic of the network of the embodiment of FIG. 1.

FIG. 3 is a schematic of a computer-implemented system for the dynamic auto-indexing and expansion of the content of an information source.

FIG. 4 is a schematic of a computer-implemented system for the dynamic auto-updating of the content of an information source.

FIG. 5 is a schematic of an embodiment where the client-side communication is not located on the user machine.

FIG. 6 is a schematic of a second embodiment where the client-side communication is not located on the user machine.

FIG. 7 is a schematic of a third embodiment where the client-side communication is not located on the user machine.

FIG. 8 shows an embodiment of the GUI and one possible configuration of the customized content.

### DESCRIPTION OF THE PREFERRED EMBODIMENTS

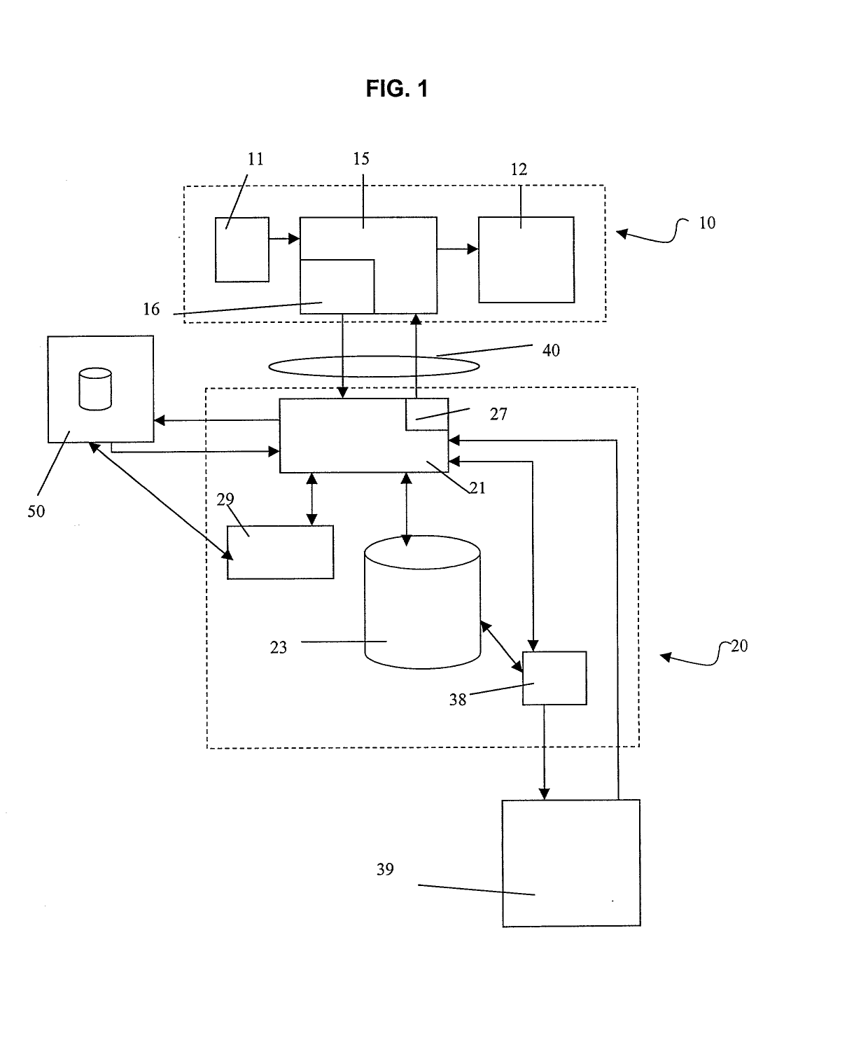

Turning to FIG. 1, an embodiment of a system for the dynamic customization of user-requested content is shown. A representative client machine 10 is a personal computer (“PC”) that includes computing architectures of various manufacturers, such as Apple, Compaq, IBM, Dell, Sun, and the like, running an operating system (“OS”) (not shown) such as MacOS, BeOS, Linux, Windows 98, Windows NT, Microsoft Windows 2000, and the like. In other embodiments, the client machine is a personal digital assistant (“PDA”), a voice over IP device, or a cellular telephone or other wireless device. The specific type of client machine used in an embodiment of the invention is a design choice for those skilled in the art, and is not critical to the invention. The client machine 10 includes a user interface 11, for example a keyboard, mouse, or touch-screen, and a display 12. In an embodiment, the client machine 10 further includes a browser 15, such as Netscape Navigator 4.0 (or higher) or Internet Explorer 4.0 (or higher), and support for an application plug-in.

As used herein, “client” or “client machine” should be broadly construed to mean any computer or component thereof, directly or indirectly connected or connectable in any known or later-developed manner to a computer network, such as the Internet. The term “server” should be broadly construed to mean one or more computers, computer platform, an adjunct to a computer or platform, or any component thereof. Of course, a “client” should be broadly construed to mean one that requests or gets the content, and “server” to mean the entity that provides or downloads the content. The client and server connections may be via modem, broadband, wireless or any other known or later-developed connection scheme. In certain embodiments, the client and server are located on the same machine, and in other embodiments, the client and server are each located on separate machines.

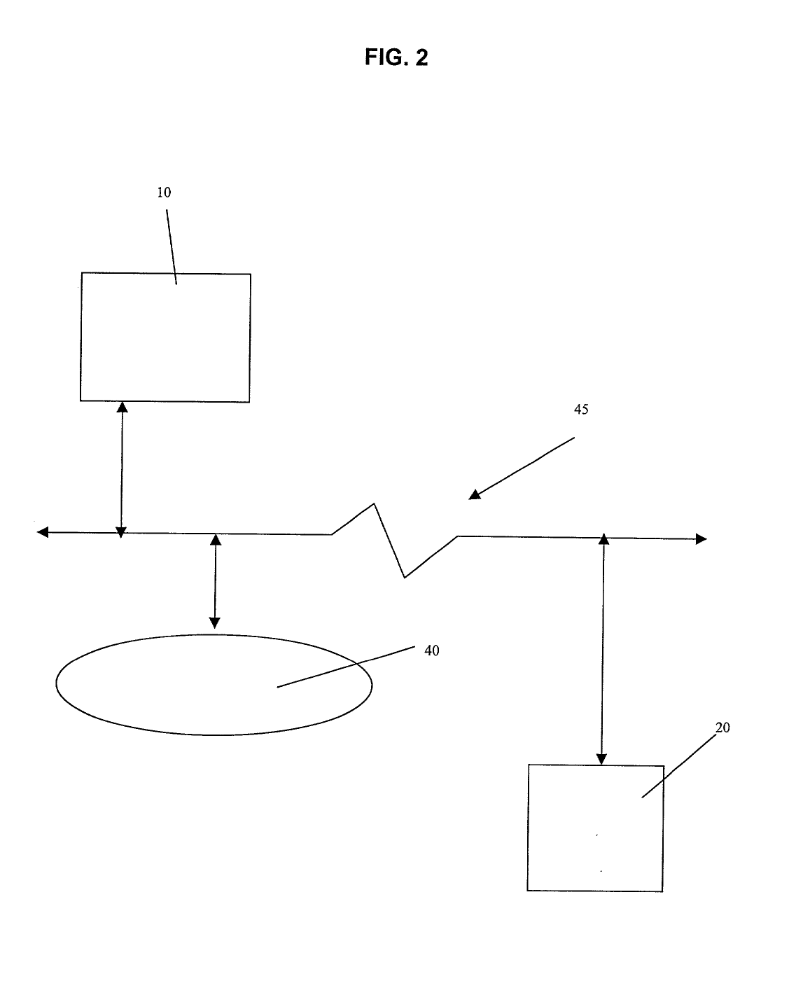

In an embodiment, a client 10 is used to access the information sources of a network, such as servers and the Web. In certain embodiments, this client 10 includes a browser. In other embodiments, the client is browser-less. FIG. 2 shows a client 10 connected to a network 45. A server platform 20 is also connected to the network. In a preferred embodiment, the server platform includes a first information source (not shown in FIG. 2.) In the embodiment of FIG. 2, a second information source 40 is also connected to the network. An example of the second information source is the Web. Thus the network-connected client 10 can access second information source 40 or the server platform 20 via the network. In certain embodiments (not shown), the server platform 20 is a part of the Web.

Returning to FIG. 1, the client 10 runs an HTML-compatible browser 15, such as Netscape Navigator or Microsoft Internet Explorer that can communicate via HTTP protocol and interpret HTML. The term “HTML” as used herein refers to HTML code, as well as HTML derivative code such as DHTML, XML and the like. In the embodiment of FIG. 1, using a user interface 11 at the client machine 10, for example a browser interface, a user specifies a request for a content item, for example by entering an URL.

The browser, communicating via HTTP protocol, sends the user request to an information source hosting the specified content at the URL. The information source returns the HTML and related content associated with that URL. As used herein, “content” should be broadly construed to mean any file, page, graphic, video, audio or other known or later-developed information requested by a user from an information source. The particular types of content to be used are design choices for those skilled in the art, and are not critical to the invention. The content may be represented in a variety of languages. Exemplary languages include English, German, French, Chinese, or Japanese. The content is not limited to any particular alphabet. Content may be expressed in, for example, the Roman alphabet, the Hebrew alphabet, the Cyrillic alphabet, the Chinese alphabet, or any other method of expressing a language. The particular languages or alphabet used are design choices for those skilled in the art are not critical to the invention. In the preferred embodiment of FIG. 1, a first information source 23 resides on the server platform 20 and a second information source 40 is the Web. In the embodiment of FIG. 1, both the first information source 23 and the second information source 40 have the requested content item.

The client 10 includes a first application program 16. In the preferred embodiment, the first application program is a browser plug-in (“BPI”) that sends a user request for a content item to the customization server platform 20 via a network. The browser 15 provides extensions to enable application developers to extend or customize the core functionality of the system through a BPI. The BPI of the preferred embodiment extends the core functionality of the browser by tracking the user's behavior, interfacing to a customization server, presenting alternative search paths or links based on the user's interests and choices, and displaying content, to name a few representative functionality extensions.

The BPI may be downloaded from a site or otherwise loaded on the client machine. The BPI, once loaded, installs itself and activates itself, opening a window within the browser's portion of the display. The BPI may be activated or deactivated either by the user or upon certain events that occur within the system.

In a preferred embodiment, the server platform 20 includes a first information source 23 having a plurality of content items, including the user-requested item, as well as other information. In a preferred embodiment, the first information source is a database. As used herein, the term “database” should be broadly construed to mean a computer program optimized for creating, storing, manipulating, and reporting on stored information.

As the user navigates through the information source, each user requested content item is identified as belonging to a particular category. A category is a logical grouping of information. For example, the content item “diamond” might be identified as belonging to the category “gems” or the category “baseball” or another category. A categorizer is a system that receives information and applies various matching techniques to identify the information as belonging to a particular category. In certain embodiments, the categorizer is a human being. In the embodiment of FIG. 1, the categorizer 50 is a machine. In some embodiments, the categorizer is a dedicated hardware device, such as an ASIC or other hard-coded chip or processor. In other embodiments, the categorizer is a software module or program. The precise nature of the categorizer is a design choice for those skilled in the art, and is not critical to the invention. While the embodiment of FIG. 1 shows the categorizer external to the server platform 20, in certain embodiments, the categorizer is included in the server platform. In other embodiments, the categorizer is included in the client machine. The location of the categorizer is a design choice for those skilled in the art, and is not critical to the invention.

Any suitable categorizer 50 may be used such as the categorization module available from Autonomy, or substantially equivalent categorization modules such as Hummingbird's DOCSFulcrum, IBM's Intelligent Miner for Text, or Excalibur's KnowledgeRetrieval. In certain embodiments, the information categorized is textual or HTML data. The matching techniques include neural networks, Bayesian probabilities or other advanced pattern-matching technologies such as KNN (K Nearest Neighbor). The concept matching techniques enable the categorizer to identify patterns in the received digital information and to look for similar patterns in other sources quickly and automatically.

In certain embodiments, the categorizer matches the content with similar content by analyzing the patterns of symbols and contexts. The symbols may be text characters, represented in a variety of languages. Exemplary languages include English, German, French, Chinese, or Japanese. The symbols may also be non-textual material, such as pictures, computer graphics, sound recordings, or any other content expressed in symbolic format. The symbols are not limited to any particular alphabet. Textual symbols may be expressed in, for example, the Roman alphabet, the Hebrew alphabet, the Cyrillic alphabet, the Chinese alphabet, or any other method of expressing text. Graphics symbols may be expressed in, for example, JPEG, GIF, MPEG, or other formats. Audio symbols may be expressed in WAV, MP3, or other formats. The particular symbols to be analyzed are design choices for those skilled in the art, and are not critical to the invention.

An application software program in the categorizer can be trained to automatically classify documents by relating them to pre-defined categories. More specifically, categorizer programs are created or trained with examples of content characteristic of each category. By training the program with representative content that has been previously categorized, the program learns the patterns that are most significant across content in each category. Then, as new content is presented, the program can quickly determine how well the new content fits into each category.

Various category creation methods are available for use in categorizers. In certain embodiments, a supervised creation method is used, and in other embodiments, an unsupervised creation method is used. In the supervised method, exemplars of the category are provided to the categorizer and the program is told to which category the exemplars belong. The categorizer then “learns” in some fashion that varies dependent on the underlying technology. In the unsupervised method, the categories are constructed automatically by a system that “looks” for logical groupings of data.

In a preferred embodiment, an application program 29 is utilized to train the categorizer 50 according to a specific taxonomy scheme. When the categorizer 50 receives the content associated with an uncategorized URL from the customization server 21, it assigns the URL to a category specified by the taxonomy application program 29.

Thus, the categories to which the categorizer 50 assigns content items are defined by the taxonomy. Accordingly, categorized content items arriving at the server platform 20 can be identified as matching a category of the taxonomy by the categorizer 50. Alternately, the taxonomy application program can identify the category in certain embodiments.

The taxonomy not only specifies the categories that can be assigned to content, but also describes the relationships between the categories. In certain embodiments, the taxonomy is manually constructed by creating categories that encompass possible Web content. In a preferred embodiment, humans or expert systems that have taxonomic knowledge of specific areas, such as sports, science, etc., perform the categorization. In certain other embodiments, the taxonomy is created automatically by use of a clustering program that logically categorizes content.

The taxonomy is composed of categories that can be hierarchically structured. As such, it is a representation of how the content of the first information source can be categorized. The content itself need not actually be grouped or stored in a particular location or sector of the database.

In certain embodiments, the taxonomy scheme is user-augmented, which means that users can construct additional categories to add to the taxonomy scheme. In certain embodiments, a special user interface for creating categories resides on the customization server. The user selects terms and content and the customization server automatically creates categories that augment the taxonomy application program.

In one embodiment, the user selects a “create category” process in the BPI 16, which the BPI 16 sends to the customization server 21. The customization server 21 sends an HTML page, which is displayed in the BPI 16. The user can select topics within the page to include in the new category. The customization server 21 uses the topics selected by the user to train the categorizer 50 to identify a new category using the training process previously described. The user may direct the customization server 21 to associate the new category with various actions, for example the action “display content.” The new categories, content, actions and associated information are stored in the first information source 23 and are incorporated into the customization system.

The content of each URL displayed in the browser is categorized, effectively assigning it to the category or categories of the taxonomy that most closely match the context of the content. In a preferred embodiment, the categorization information, identifying the category or categories most closely matching the viewed URL's context, is sent to the presentation circuit 27, which composes it and sends it to the client 10 to be displayed in the BPI 16. In the preferred embodiment, a list of contextually similar URLs is displayed in conjunction with the category information.

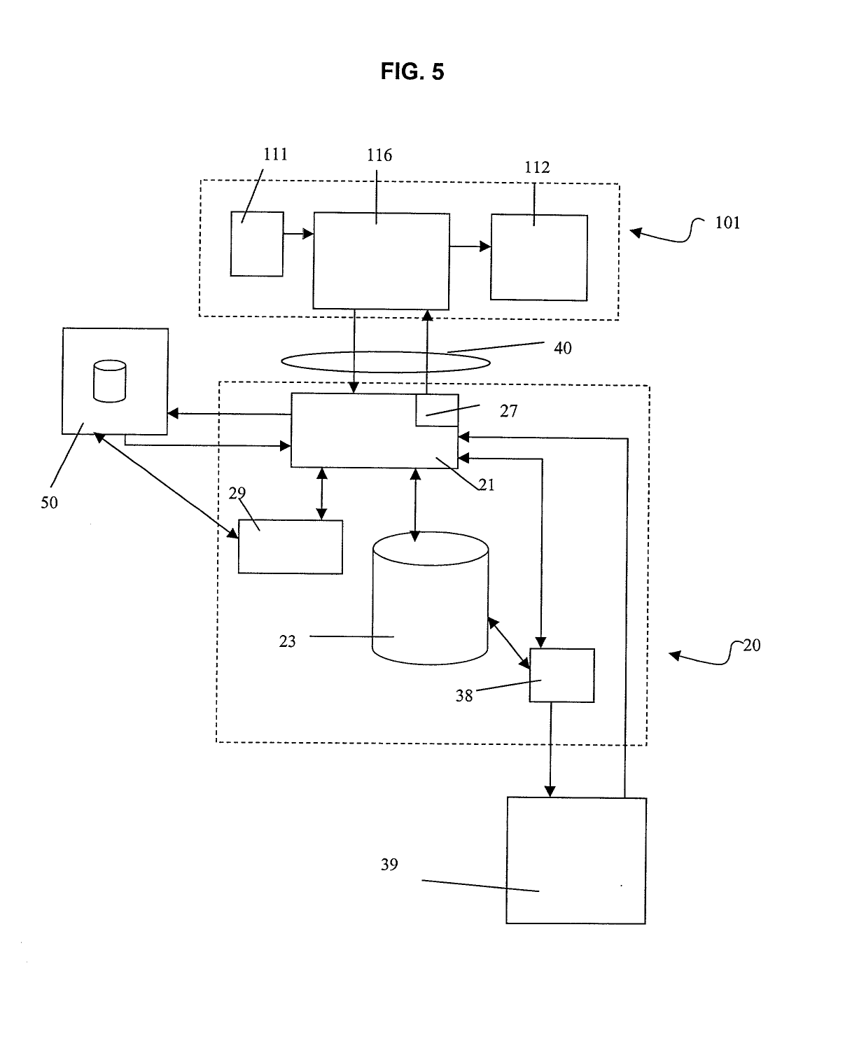

A first application program running in conjunction with a client side browser is the preferred embodiment because the system is more easily implemented. However in certain embodiments, the client-side communication and display are not dependent on a browser and not localized to user machines. Similar functionality as that described above can be provided by a second application program that can reside on an individual client machine or at other remote locations such as a subscriber's server system. For instance, in FIG. 5, a second application program 116 accesses the information sources in the same manner as described in previous embodiments that use a first application program and a browser. The second application program 116, which resides on the client machine 101, provides its own display 112 and user interface 111. In the embodiment of FIG. 5, the second application program communicates directly with the server platform 20. The accessed information, which can include category or other analysis information, can be displayed immediately by the second application program 116 or it can be stored in an information source (not shown) for later display.

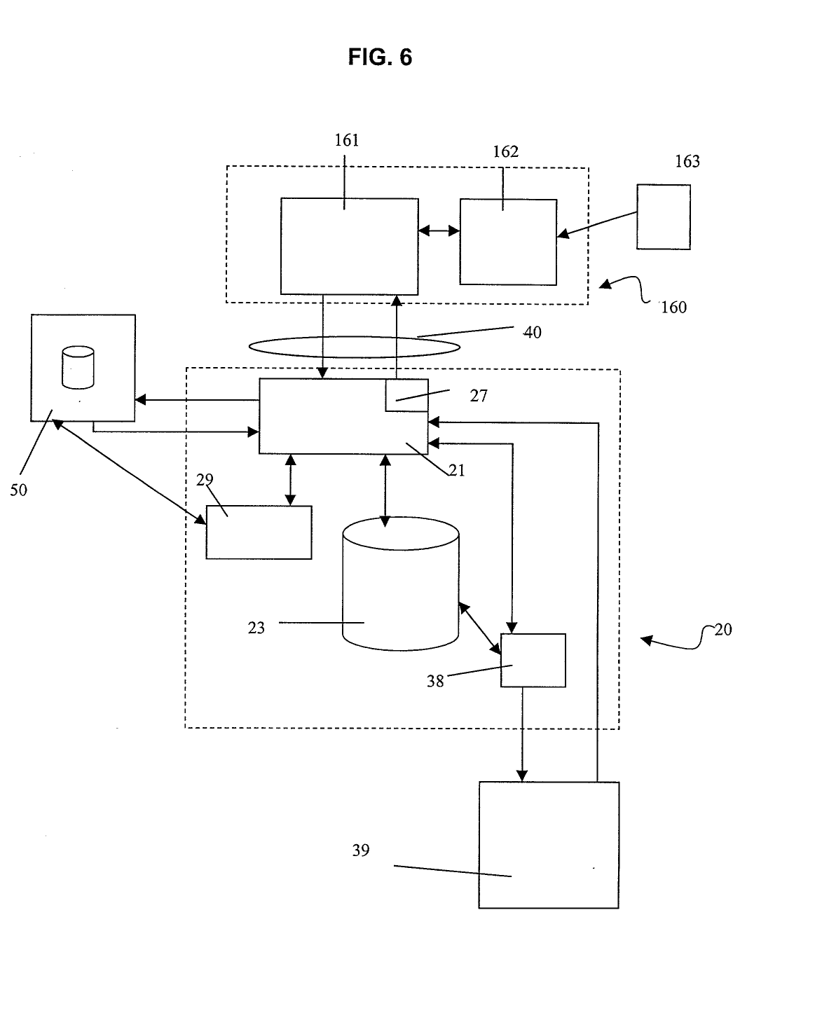

In another embodiment, as shown in FIG. 6, a third application program 161 runs on a subscriber's server system 160. An example of a subscriber's server system is a web server and related applications hosting subscriber's web site. In the embodiment of FIG. 6, the third application program 161 runs in “real-time” with the subscriber's web server 162. When a user client 163 requests HTML content, such as a page of web content, from the subscriber's web server 162, the web server runs the third application program 161, which transmits the content associated with the requested page to the customization server platform 20. The customization server platform 20 performs categorization and the other analyses described herein and returns the customized content to the third application program 161. The third application program 161 makes the customized host content available to the subscriber website for optional display as part of the requested subscriber page and returns the customized content to the user's client machine 163.

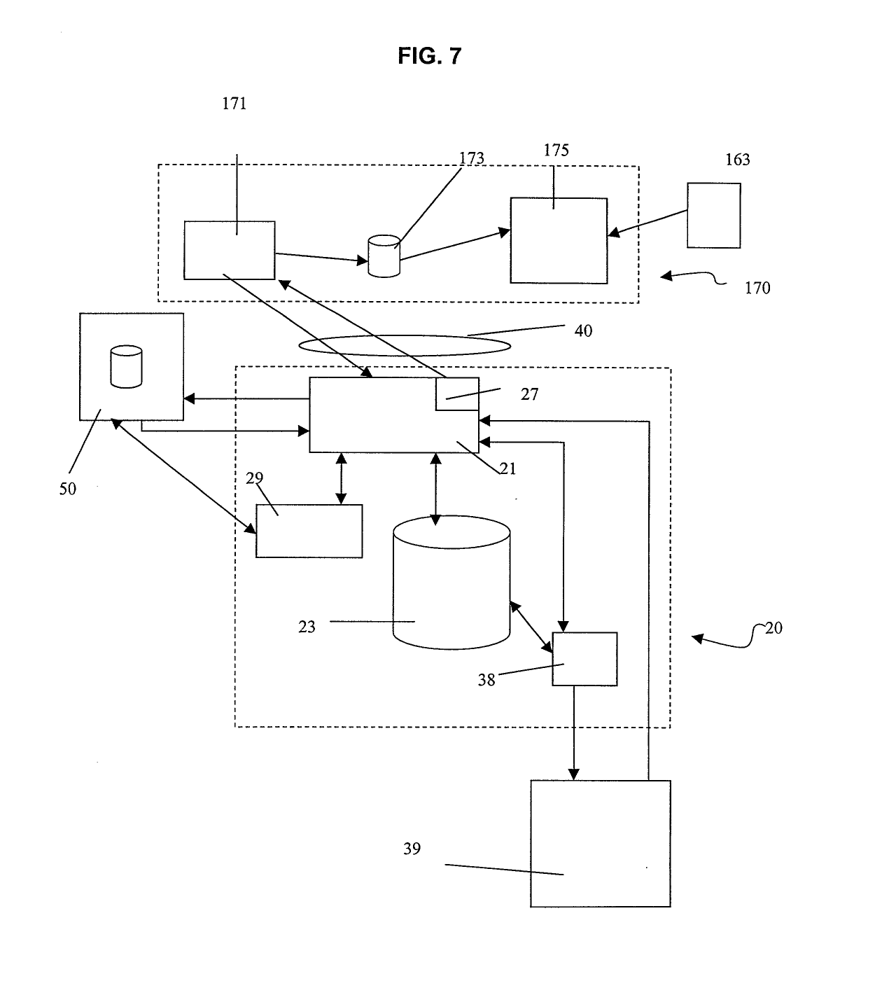

In another embodiment, as shown in FIG. 7, a fourth application 171 runs in conjunction with the subscriber's server system 170, however it does not run in real-time with user requests for HTML data. Sometime after a page of the subscriber's content is created and prior to a request for the content by a client 163, the fourth application program 171 sends the new page of content to the customization server platform 20 which performs the various analyses as described elsewhere herein. The customization server platform 20 returns the customized display content to the fourth application program 171, which stores the customized information in a database 173 that is accessible by the web server 175. Later, when users access the subscriber's Web site from the client machine 163, as part of the normal website operation, the customized data is retrieved from the database 173 and displayed in conjunction with the requested content on the client machine 163.

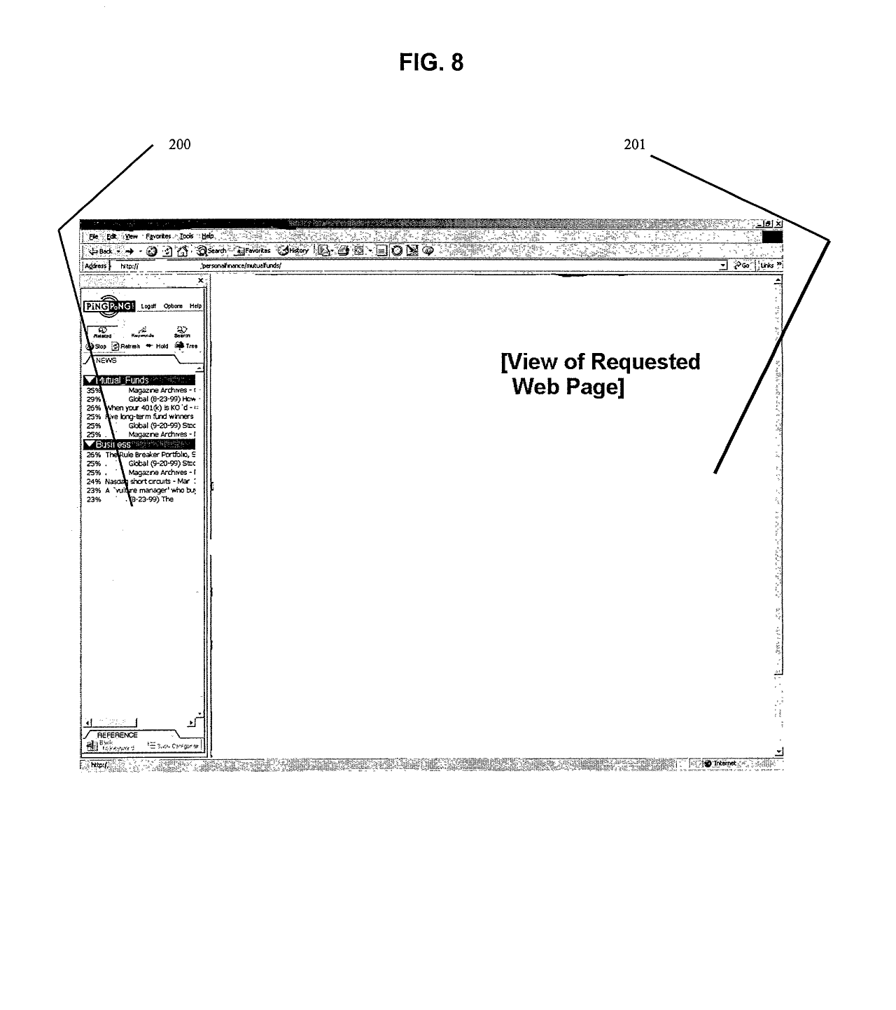

In another embodiment the client display includes an interface for viewing the content received from the customization server that is a graphical user interface or “GUI.” FIG. 8 illustrates one possible configuration of the GUI. The customization server builds the content to be displayed in the BPI and related browser window. FIG. 8 shows the BPI incorporated into the left side 200 of the browser window. The right side 201 of the browser window displays an example of a page of content. The BPI displays a list of documents that are “related” to the content of the example page. The content may be built upon a number of schemes. In a preferred embodiment, the content is built using any of the following:

Actions;

Category information, for instance the name of the category or context and degree of match with the content;

URLs of similar content and summaries according to the organizational scheme of the taxonomy;

Keywords which are extracted from the requested URL using a dictionary matching technique or other methods;

URLs associated with the keywords and similar in context to the requested URL. In one embodiment, the URLs associated with keywords are obtained in a manner analogous to the manner previously described for the identification of documents similar to the context of the requested URL.

The output of the display may be organized around a number of schemes. In a preferred embodiment, the display output is organized by Reference, News, Chat, Events, and Keywords. Keywords are, in turn, organized by Reference, News, Chat, and Events. While it is important that an organization scheme be defined for user ease, the specific type of organization scheme may vary according to user needs.

In another embodiment, the client display includes a standalone application that works without a browser. While a preferred embodiment employs a browser to simplify the development process, the browser is not required. In embodiments without a browser, the standalone application runs on the client machine, communicates with the server platform and acts as both an information requesting device and a display mechanism, displaying both the requested content and the customized content.

Certain embodiments include a telephone in place of a desktop computer system running a browser. In such embodiments, the user makes a request for content from a cellular phone and audio as well as textual information is returned for display based on the context of the requested information. Other embodiments use a WebTV device in place of a desktop computer system running a browser. The WebTV device incorporates television as part of the display mechanism. Upon request for information, audio, video and text are returned, as a group, individually or in various combinations. Each of these embodiments presents the customized content through an application running on the client device that may not accommodate a browser.

Another embodiment allows auto-indexing of audio information. Certain embodiments include a browser and other embodiments do not include a browser. In either case, the embodiments include a speech-to-text translation system to convert spoken material into text material. The text material is then placed in the first information source. Any manual or automated commercially-available speech-to-text translation system may be used. Presently, commercially-available speech-to-text translation systems are known to make mistakes in translating certain terms. However when these translation systems are used in the embodiments described above, information retrieval is improved because searching for terms in context overcomes mistakes that translation systems can make.

Other embodiments allow auto-indexing of video information. Currently, automated video and image recognition or translating devices have sufficiently matured to be used in these embodiments. However, manual translation may also be used in place of the automated systems.

Returning to the embodiment of FIG. 1, the server platform 20 includes a rules and action module 38 that stores an action and an associated rule for invoking the action. In the embodiment of FIG. 1, each action is identified as belonging to a certain category by the categorizer 50. The taxonomy application program specifies the taxonomy of the relationship of content items and actions based on their categories. If the server platform receives a request for an uncategorized content item, the content item is sent to the categorizer to be categorized according to the taxonomy as previously described.

Upon the identification of the receipt of a requested content item having the same category as the action in the rules and action module 38, the rule associated with the action invokes the action. In certain embodiments, the action is sent to the client 10 by the server platform 20. In certain embodiments, the action is sent to a subscriber 39. The subscriber 39 gives something of value to a designated agent of the host of the server platform in return for invoking the subscriber's action upon receipt by the server platform of a request for content items having the same category as the subscriber's action. In a preferred embodiment, the subscriber pays the designated agent of the host of the server platform each time one of the subscriber's actions is invoked according to the subscriber's rule upon receipt of a request for a content item having a certain category from a user.

For example, a user may request a content item belonging to the category “homes,” such as a picture of a specific vintage of home that has been listed for sale. A subscriber that is a mortgage company, has placed an action belonging to the category “homes” that is a pop-up box image of the company's mortgage rates for the day together with a rule for invoking the action. The rule tells the server platform to send the pop-up box image to the client each time that the server platform receives a user request for a content item belonging to the category “homes.” A second action, which is a bill to the subscriber, may also reside in the rules and action module. The rule, or a second rule, tells the server to send a bill to the subscriber each time one of the subscriber's actions is invoked. In certain embodiments, an action may be sent to a party other than a subscriber or client.

In a preferred embodiment, the rules and action module contains a plurality of actions. Certain actions may belong to the same category. An action may belong to a different category than another action stored in the rules and action module. In a preferred embodiment, the rules and action module includes a first action and a second action. The first action belongs to a first category and the second action belongs to a second category. A rule associated with the first action invokes the first action upon the identification of the receipt of a request for a content item belonging to the first category. A rule associated with the second action invokes the second action upon the identification of the receipt of a request for a content item belonging to the second category.

Examples of actions are displaying a second content item in the client's browser, running an application in the client's browser or BPI or host server, running an applet in the client's browser or BPI or host server, running a banner ad in the client's browser or BPI, connecting the client to an auction site, connecting the client to a chat room, sending an email message, sending a phone message, sending a paper message, causing the browser or the BPI to have a certain look and feel or “skin,” send data to a system or subsystem coupled to the client, creating and sending an invoice, altering the organization of display material, printing an airline ticket, creating and sending display content, and the like.

The actions can be prescriptive or proscriptive and can be intra-system actions or inter-system actions. Prescriptive actions are essentially positive filters that allow or invoke the display of content or initiate system operations such as communication and applications. Proscriptive actions are essentially negative filters that preclude certain kinds of content, displays, communication or applications. Proscriptive actions can be used, for example, to prohibit the viewing of certain kinds of content. As an example, a parent might permit their child to view football content and, therefore, allow him or her to use a “football persona” that might include categories that specify prescriptive actions that match news pages containing information about the NFL and the family's favorite NFL team and initiate related banner ads and other content. However, the parents might want to disallow the viewing of sexually explicit material and therefore include in the child's “football persona”, categories that invoke proscriptive actions that block the viewing of any sexually explicit material. Additionally, the latter categories might also include prescriptive actions. An example would be a category that includes the proscriptive action of blocking the viewing of any sexually explicit material and the prescriptive action that automatically dial the parent's pager, notifying the parent that the child attempted to view the proscribed content.

In certain embodiments, the actions are pre-specified by the server platform host. In other embodiments, the actions are pre-specified by the user. In yet other embodiments, the actions are pre-specified by third parties. In a preferred embodiment, the third parties are advertisers or agents of advertisers (collectively, “subscribers”) who pay revenue to the server platform host in exchange for the server invoking the action(s) in response to the receipt by the server platform of requests for content of certain categories. If executed on the client machine the presentation circuit 27 of a preferred embodiment delivers the action to the browser 15 or BPI 16 substantially simultaneously with the presentation of the content from the requested URL.

Another embodiment is a computer-implemented system for the dynamic customization of content to a user-specified persona. A persona represents a user's interest(s). For example, the user may have a “motorcycle-racing persona” or a “cooking persona” or a plurality of other personas. A persona may be defined by the category or group of categories to which the persona belongs, the actions it can invoke, or customized display content that distinguishes the persona's appearance. In a preferred embodiment, the persona is a user-specified persona.

Referring again to FIG. 1, the system of the embodiment includes a network-connected client 10 that has a browser 15 that sends a user-specified persona belonging to a first category to the network and a customization server platform 20 that is connected to the network and receives the persona from the client 10. The server platform 20 includes a first information source 23 for storing the persona, an application program 29 that specifies a taxonomy of the relationship of personas and actions based on their categories, and a rules and action module 38. The rules and action module 38 has an action belonging to the category and a rule for invoking the action upon the identification of the receipt of a persona having the same category as the action.

In a preferred embodiment, the BPI 16 communicates the user-specified persona to the customization server 21, which records the persona in the first information source 23, executes any associated actions, transmits any associated inter-system actions to the target system or systems and returns any intra-system actions, including display content and other information to the BPI 16, which updates the display 12 to reflect the new persona and executes any returned intra-system actions. In certain embodiments, the BPI 16 identifies the persona within the BPI 16 or browser 15, by opening a window that is color and content-coded to the persona or identifies the persona by other means.

In certain embodiments, the customization server 21 records the URLs requested by the user who chose the persona as part of the persona information archived in the first information source 23. By maintaining a count of the various URLs chosen by different users utilizing the same persona the server platform 20 provides a means to determine the most popular URLs of a given persona, or user interest. The list of URLs accessed by all users employing the client user's current persona can be optionally sent to and displayed in the BPI 16. Moreover, the list of URLs can be ordered in various ways useful to the user, for instance by frequency of request.

In a preferred embodiment, subscribers may establish rules that direct advertising to certain personas, where the advertising consists of certain pre-specified actions to be invoked upon the identification of a persona belonging to a certain category or categories. By marketing to one or more personas, as opposed to specific user, advertising can be more specifically targeted than is conventionally possible, because the personas represent specific interests. By contrast, conventional Web marketing techniques rely on feedback from individual users or require marketers to guess about user interests. By marketing to personas, information tied to a specific user remains private, and instead, the subscriber is given access to market to a persona that may be the interest of a number of users.

Moreover, subscribers would likely pay varying amounts based on the degree of specificity of the target personas to which the action is provided. In this preferred embodiment, the server platform 20 includes an action that is the transmission of a bill in the rule and revenue module 38 that automatically bills a subscriber 39 for the delivery of a subscriber-specified action to a client 10 by the server platform 20. In certain embodiments, the revenue per action is tied to the degree of marketing specificity of the persona as pre-defined by the subscriber in the rules and action module 38. Marketing specificity can be determined by the relationship of categorization level in the taxonomic hierarchy. Thus a lending company may pay a certain amount $x for delivery of a banner ad on any user-requested URL for a consumer good, while a given automobile manufacturer may pay $y, where y>x, for placement of its banner ad on any user-requested URL containing information about a particular year and make of automobile. While the former rule invokes an action in response to a request for a content item of a very high level or general category (consumer good) that lacks target-market specificity, the latter invokes an action in response to a request for a content item of a very low-level or specific category (year and make of automobile) having valuable target-market specificity.

Thus, the preferred embodiment includes a revenue model that provides a gradient of increasing revenue per action based on the degree of specificity of the category of the requested content as it relates to the subscriber's target market.

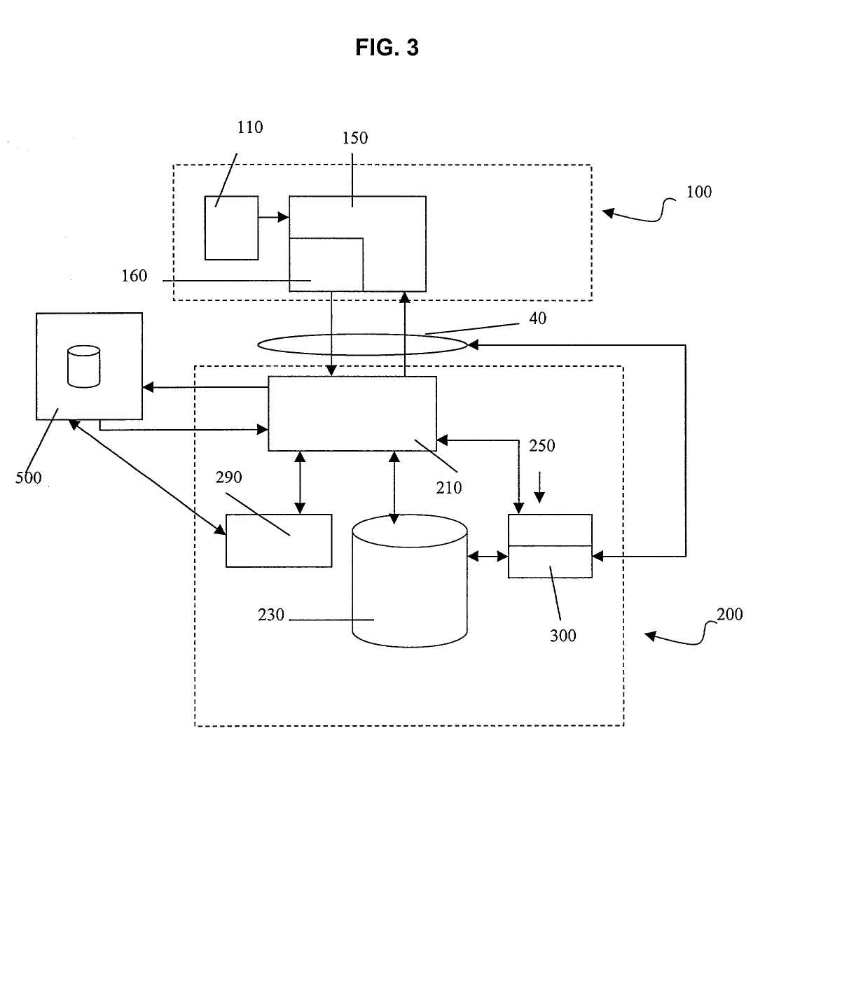

FIG. 3 shows a third embodiment that is a computer-implemented system for the dynamic auto-indexing and expansion of the content of an information source based on user-requested content. The system includes a network-connected client 100 that has a browser 150 that sends a user request for a content item belonging to a category to the network, and a customization server platform 200 connected to the network that receives the request for the content item. The server platform 200 includes a first information source 230 that has the content item, an application program 290 that specifies a taxonomy of the relationship of content items and actions based on their categories, and an information retrieval module 250. The information retrieval module 250 includes a front-end application program 300 for retrieving the content item and its linked category content from a second information source 40 on the network and storing the retrieved content in the first information source 230. In a preferred embodiment, the linked category content is all of the content linked to the requested categorized content item. In a preferred embodiment, the second information source is the Web. As a result, the first information source 230 is continuously supplied with current Web content by the information retrieval module 250. In a preferred embodiment, the front-end application program 300 is a FETCH program and the second information source 40 is the Web. The FETCH program acquires Web content, analyzes it and stores it in the first information source 230 in order to provide the system with a local source of large amounts of Web data. Such a stocked local source enables the system to present alternative information sources to the user and eliminates processing overhead time in responding to user requests, thereby enhancing system performance.

When the user requests an URL, it is sent to the FETCH program, which triggers the program to retrieve the content associated with the URL from the Web. Thus, the users help stock the information source by providing URLs that the FETCH program uses to provide associated content. The FETCH program uses the requested URL as a starting point and goes to the URL's site. There, it recurses through the various links and references contained within the site gathering the content referenced by the initial URL. Acting much like a browser, the FETCH program requests the HTML content located at the URL's site. It then stores the URL and the HTML content associated with that URL in the first information source 230. The FETCH program then peruses the acquired content for new URL links and server locations specified in the HTML content and, in turn, recurses through each link and location.

In certain embodiments, the front-end application program will acquire all of the content associated with a starting URL. In other embodiments, the front-end application program may recurse to certain specified depths in the site's hierarchy. As the front-end application program retrieves content, it performs various analyses and stores the analyses, along with the content and URL in the first information source 230. Analyses include categorization information, date and time stamp calculation, and CRC.

In preferred embodiments, as the Web content or other data is viewed by users, the category of the viewed content as it relates to the taxonomy is identified by the server platform. Thus, the server platform includes a means for auto-indexing the Web. Whereas most Web indexing methods require human intervention to pre-locate content and place the content in fixed categories, the auto indexing means of this embodiment automatically takes the content requested by a user and dynamically categorizes it “on the fly” based on its context. Unlike conventional categorization schemes, the auto-indexing means can be easily reconfigured or user-defined and does not require the manual determination and placement of content.

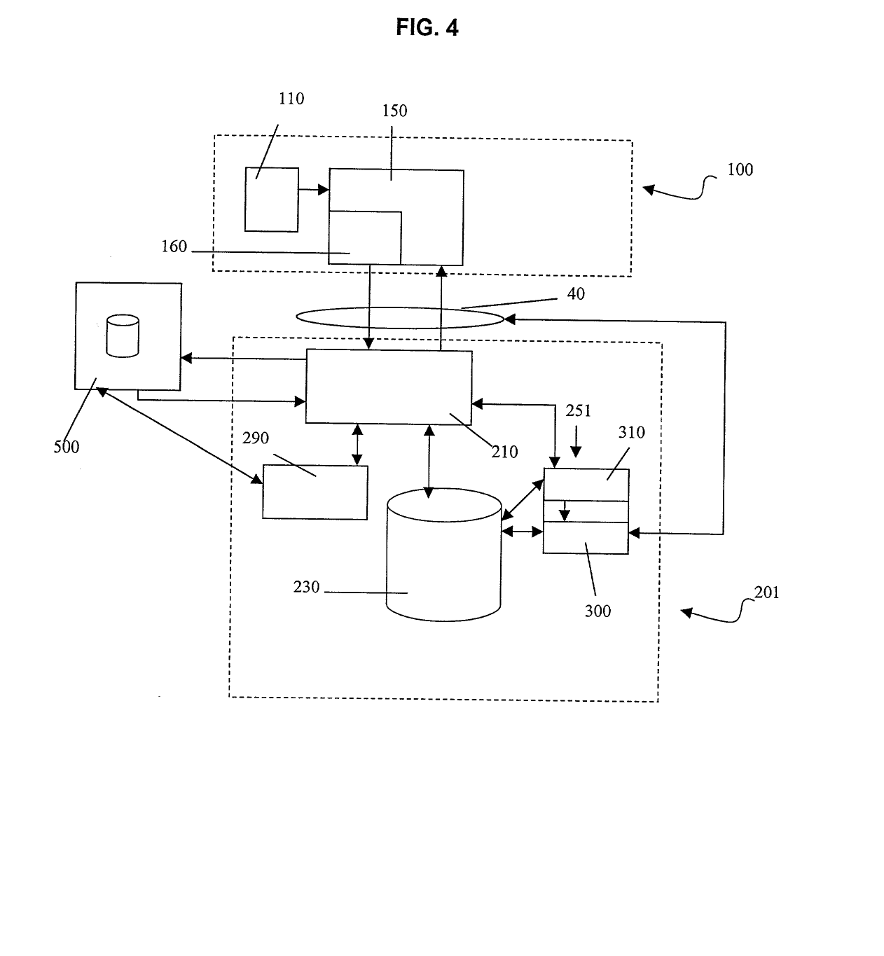

FIG. 4 shows a fourth embodiment that is a computer-implemented system for the dynamic auto-updating of the content of an information source based on user-requested content. The system includes a network-connected client 100 that has a browser 150 that sends a user request for a content item having a second version indicator, the content item belonging to a category, to the network, and a customization server platform 201 connected to the network that receives the request for the content item. The server platform 201 includes an application program 290 specifying a taxonomy of the relationship of content items and actions based on their categories, and an information retrieval module 251 and a first information source 230. The first information source 230 has the content item having a first version indicator. For example, the user may send a request for an URL, where the content associated with the URL is stored in the first information source 230. However the URL requested by the user may include a second version indicator that denotes that the content of the URL requested by the user was created subsequent to the creation of the content having the first version indicator that is stored in the first information source 230. Examples of version indicators are date stamps and CRC values. In the above example, the user has requested a version of a content item that has been updated from the version stored in the first information source.

The information retrieval module 251 includes a front-end application program 300 and a back-end application program 310. The back-end application program 310 has a means for comparing the version indicator of a requested content item with the version indicator of the content item stored in the first information source. For instance, the backend application program 310 retrieves the date stamp and the CRC (cyclic redundancy check) value from the URL (part of a normal HTTP request of the URL) and compares those values with the comparable values it saved in the information source at the time the URL was first accessed and stored in the information source. When the back-end program 310 detects that version indicators do not match, it sends a request for the content item, together with its URL, to the front-end program 300. The front-end program 300 has a queue for storing URL requests (not shown) and receives the URL from its queue. It then retrieves the requested content item and its linked category content from a second information source 40 connected to the network and stores the retrieved content item and linked category content in the first information source 230. Thus the information retrieval module 251 of this embodiment reviews the information stored in the first information source and updates the information as necessary.

In certain embodiments, the back-end program 310 may also operate independently of the BPI 160 or user requests for URLs from the BPI 160. In these embodiments, the back-end program 310 periodically monitors version indicators of new content arriving at the first information source 230, regardless of the source of the content. For instance, information linked to content supplied by the front-end program 300 may include version indicators that by comparison denote obsolete stored content in the first information source 230. In such a case, the back-end program 310 would detect the mismatch of version indicators during its monitoring of the first information source 230 and would determines that content stored in the first information source 230 is out of date or otherwise obsolete. In such a case, the back-end program 310 would request that the front-end program 300 as previously described retrieve the updated content.

In a preferred embodiment, the back-end program 310 is a SITEWATCH program. In order to determine if a stored page is current or not the SITEWATCH program compares the version indicators, such as the datestamp and CRC values, of a stored content item with the datastamp and CRC for the URL of the same content item that has been newly provided by the front-end application program. If the two version indicators do not agree, then the SITEWATCH program specifies that a new version of the content is available and should be retrieved by the front-end application program. The SITEWATCH program specifies the request for retrieval by placing the URL in the queue that the front-end application program monitors. Thus, in this embodiment, the Web content that the front-end application program retrieves is associated with an URL provided by SITEWATCH and not by the user.

Another embodiment is a method for implementing the dynamic customization of user-requested content. The method includes the step of providing a computer-implemented system that includes a network-connected client having a browser and a network-connected customization server platform. The customization server platform includes a taxonomy application program and a rules and action module that has an action and a rule for invoking the action upon the identification of the receipt of a request for a content item of the same category as the action from the client. The method further includes the steps of receiving a request at the server platform from the client for a categorized content item and identifying the category of the requested content item according to the taxonomy. The method then causes the rule in the rules and action module to invoke the action having the same category as the content item. In a preferred embodiment, the server platform sends the action to the client. In other embodiments, the action can be sent to a subscriber or a third party other than the client or the subscriber.

In a preferred embodiment, the customization server platform includes an information source having the categorized content item and the server platform retrieves the content item from the information source and sends it to the client, subscriber or third party. In certain embodiments, the server platform sends the content item together with the action to the client. In other embodiments, the server platform may send the action, which is a first action such as a display modification, and the content item to the client and send a second action invoked by the rule to the subscriber. For instance, the second action could be a bill for sending the modified display action to the client.

In certain embodiments, the user may request a content item that is uncategorized. In such a case, the system further includes a categorizer and the server platform sends the uncategorized content item request to the categorizer. The categorizer categorizes the content item according to the scheme defined by the taxonomy application program and returns the categorized content item to the server platform where it can now be identified according to the taxonomy.

A representative example of a preferred embodiment of the method refers to embodiment of the system of FIG. 1. The user specifies an URL associated with the desired content by entering the URL in the user interface 11 by typing in the URL, clicking on a hyperlink or by another method known now or in the future. The BPI 16 sends the URL to the server platform 20. In embodiments that do not include a BPI, the browser 15 sends the URL to the server platform 20. Upon receiving the requested URL, the server platform 200 identifies the category of the URL. Alternately, if the URL is uncategorized, the customization server 21 sends the URL to the categorizer for categorization according to the taxonomy scheme. The taxonomy application program identifies the category of the URL and the customization server 21 retrieves the content item from the first information source 23.

The server platform 20 includes a rules and action module 38 that includes at least one action associated with the content item in the first information source 23. The customization server 21 causes the rules and action module 38 to invoke the action having the same category as that identified for the requested content item. If the action invoked is, for instance, to send a banner ad to the client 10, the banner ad is retrieved from the first information source and sent to the browser 15 or BPI 16 substantially simultaneously with the URL content by the presentation circuit 27 of the customization server 21. As previously described, the server platform can send any number of actions to the client, to a subscriber or to a third party.

In a preferred embodiment, the method includes the step of finding content in the first information source 23 that is of the same category as that of the requested URL. The contextually similar URLs are then sent by the presentation circuit 27 to be displayed as links in the browser 15 or BPI 16, thereby providing an additional means of navigation for the user and providing the user with an efficient means to access to similar content.

In some embodiments, the customization server acts as an Internet Protocol (“IP”) proxy. An HTTP request for an URL by the client includes the IP address of the requesting client. When a user requests an URL, the customization server does not pass the client's IP address on in the request for the content associated with the URL. Instead, it records the requesting IP address in the first information source, replaces it with its own IP address in the HTTP request and forwards the request for the URL. Upon return of the requested URL content, the customization server retrieves the client's IP address from information source, replaces its IP address with the address of the requesting client and returns the requested content to the client. This proxy system is useful in cases where the requested content does not reside in the first information source and the information retrieval module must retrieve the content item from the Web. In such a case, the user's IP address is shielded from the Web, enabling the user to remain anonymous and still “surf” the Web.

Similarly, in certain embodiments, the customization server acts as a cookie proxy. Cookies are used by Web sites to store information about users on the client machines. In embodiments where the customization server acts as a cookie proxy, it intercepts any requests to set or get cookies, keeping the user's machine free of cookies and any user-specific information that the cookie may contain. If the Web site of the requested URL attempts to set any cookies on the client machine, the customization server intercepts the request and records the cookie, indexed by the persona in use at that time, in information source. If the Web site of the requested URL attempts to get cookies from the client browser, the customization server retrieves any cookies associated with the client's current persona that have been previously stored in information source and returns them to the Web site of the requesting URL. Thus, the user has greater security because cookies are not stored on the user's machine and the Web site can not get access to the user's machine to commit unauthorized acts. Additionally, the user enjoys greater privacy because the cookie is not associated with the specific user, but is instead associated with a persona of the user. Thus, the user and the user's specific interests are shielded from the Web site.

Table 1 shows a series of steps taken by the various components of a preferred embodiment of a system having a BPI from the time the user downloads the BPI through the delivery of content and related actions to the user and billing to the subscriber. The arrows indicate the direction of information flow to or from the BPI, to or from the browser and to or from the server platform.

TABLE 1

| | BPI | | Browser | | Server Platform |
|---|---|---|---|---|---|
| 1 | | | User starts | | |
| | | | browser | | |
| 2 | | ← | User | | |
| | | | navigates to | | |
| | | | a site and | | |
| | | | downloads | | |
| | | | BPI | | |
| 3 | BPI installs | → | | | |
| | and activates | | | | |
| | itself | | | | |
| | opening up a | | | | |
| | window | | | | |
| | within | | | | |
| | the browser | | | | |
| 4 | | ← | User selects | | |
| | | | a persona | | |
| 5 | Sets state to | → | | | |
| | the selected | | | | |
| | persona; | | | | |
| | changes BPI | | | | |
| | window to | | | | |
| | reflect | | | | |
| | the persona; | | | | |
| | sends | | | | |
| | categorized | | | | |
| | persona to | | | | |
| | customi- | | | | |
| | zation | | | | |
| | server | | | | |
| 6 | | | | | Customization server updates |
| | | | | | records in the first |
| | | | | | information source |
| | | | | | and retrieves any |
| | | | | | action associated with the |
| | | | | | persona |
| 7 | | | | ← | Interprets any action, such |
| | | | | | as the creation of content |
| | | | | | or the specification of activity |
| | | | | | to be performed by the BPI. |
| | | | | | Sends action(s) and/or content |
| | | | | | to BPI; sends content to the |
| | | | | | browser |
| 8 | BPI displays | | Browser | | |
| | content and/ | | displays | | |
| | or performs | | content. | | |
| | action. | | | | |
| 9 | | ← | User | | |
| | | | specifies an | | |
| | | | URL to view | | |
| | | | in the | | |
| | | | browser via | | |
| | | | the user | | |
| | | | interface. | | |
| 10 | Intercepts | → | | | Customization server requests |
| | the URL and | | | | category identification of the |
| | sends the | | | | URL from the taxonomy |
| | URL and | | | | application program and |
| | persona | | | | requests and retrieves URL |
| | identification | | | | content from the first |
| | to the | | | | information source. The back- |
| | customi- | | | | end program determines |
| | zation | | | | whether the stored content |
| | server. | | | | associated with the URL is the |
| | | | | | most current version. If the |
| | | | | | first information source |
| | | | | | contains content with a first |
| | | | | | version indicator and the |
| | | | | | requested URL has a second |
| | | | | | version indicator, then |
| | | | | | the back-end program sends |
| | | | | | the URL to the queue of the |
| | | | | | front-end program. |
| | | | | | The front-end program |
| | | | | | retrieves the content from the |
| | | | | | Web site of the URL having |
| | | | | | the second version indicator |
| | | | | | and stores it in the first |
| | | | | | information source. The |
| | | | | | customization server performs |
| | | | | | various analyses on the |
| | | | | | content, including parsing |
| | | | | | keywords, and stores the |
| | | | | | analyses in the first |
| | | | | | information source. |
| 11 | | | | | Customization server also |
| | | | | | records in first information |
| | | | | | source that the URL |
| | | | | | was requested by the user's |
| | | | | | persona. |
| 12 | | | | | If the Website of the URL |
| | | | | | requests that a cookie be set, |
| | | | | | the customization server sets |
| | | | | | a cookie in the first |
| | | | | | information source |
| | | | | | corresponding to this user's |
| | | | | | persona and URL. If the |
| | | | | | Website of the URL requests |
| | | | | | a cookie, the customization |
| | | | | | server retrieves the cookie |
| | | | | | from the first information |
| | | | | | source that is associated with |
| | | | | | this user's persona and URL |
| | | | | | and returns it to the Web site |
| | | | | | of the URL. |
| 13 | | | | | If the user requests an |
| | | | | | uncategorized URL content, |
| | | | | | the customization server sends |
| | | | | | the URL to the categorizer, |
| | | | | | which may or may |
| | | | | | not be part of the server |
| | | | | | platform. The categorizer |
| | | | | | categorized the request |
| | | | | | according to the prede- |
| | | | | | termined taxonomy |
| | | | | | categories, orders the |
| | | | | | categories by degree |
| | | | | | of match and sends the |
| | | | | | categorized request back to |
| | | | | | the customization server. |
| 14 | | | | | The customization server |
| | | | | | causes a rule in the |
| | | | | | rules and action module |
| | | | | | invoke any action having |
| | | | | | the same category as the |
| | | | | | content item. |
| 15 | | | | | Records actions invoked |
| | | | | | in first information source. |
| | | | | | The rule in the rules and |
| | | | | | action module may also |
| | | | | | invoke a second action to |
| | | | | | bills the subscriber. |
| 16 | | | | | Retrieves the latest |
| | | | | | version content of the |
| | | | | | URL from the first infor- |
| | | | | | mation source and any other |
| | | | | | content of the same category |
| | | | | | as the requested URL in the |
| | | | | | first information source. |
| 17 | | | | | Retrieves analysis data and |
| | | | | | keyword parse information |
| | | | | | for the URL from the first |
| | | | | | information source. |
| 18 | | | | | Retrieves any actions and |
| | | | | | display content associated |
| | | | | | with keywords parse |
| | | | | | information from the first |
| | | | | | information source. |
| 19 | | | | | Retrieves URLs accessed for |
| | | | | | this persona from |
| | | | | | information source, orders |
| | | | | | by frequency and returns the |
| | | | | | most frequently accessed |
| | | | | | URLs. |
| 20 | | | | | Builds the content to be |
| | | | | | displayed in the BPI and |
| | | | | | related browser |
| | | | | | window using these elements: |
| | | | | | Category actions |
| | | | | | Category information (such as |
| | | | | | name or context and matching |
| | | | | | value) |
| | | | | | Requested URL content |
| | | | | | Requested URL actions |
| | | | | | Similar content URLs and |
| | | | | | their summaries grouped by a |
| | | | | | predetermined organizational |
| | | | | | structure |
| | | | | | Same category content |
| | | | | | Same category actions |
| 21 | | | Displays | ← | Sends the content and actions |
| | | | content. | | to the browser. |

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A computer-implemented system for the dynamic customization of user-requested content, the system comprising:
a network-connected client having a browser that sends a user request for a content item belonging to a category to the network;
a customization server platform connected to the network, the customization server platform receiving the request for the content item, the server platform comprising:
an information source having the content item;
an application program specifying a taxonomy of the relationship of content items and actions based on their categories; and
a rules and action module having an action belonging to the category and a rule for invoking the action upon the identification of the receipt of a requested content item having the same category as the action; and
wherein the network-connected client and the customization server platform are located on the same machine.

2. The computer-implemented system of claim 1, further comprising a categorizer for identifying the category of the content item and the action, wherein the categorizer and the network-connected client are located on the same machine.

3. The computer-implemented system of claim 1, further comprising a categorizer for identifying the category of the content item and the action, wherein the categorizer is a dedicated hardware device.

4. The computer-implemented system of claim 1, wherein the network-connected client is a personal digital assistant.

5. The computer-inplemented system of claim 1, wherein the network-connected client is a wireless device.

6. A computer-implemented system for the dynamic customization of content to a user-specified persona, the system comprising:
a network-connected client having a browser that sends a user-specified persona belonging to a category to the network;
a customization server platform connected to the network, the customization server platform receiving the persona, the server platform comprising:
an information source for storing the persona;
an application program specifying a taxonomy of the relationship of personas and actions based on their categories; and
a rules and action module having an action belonging to the category and a rule for invoking the action upon the identification of the receipt of a persona having the same category as the action; and
wherein the network-connected client and the customization server platform are located on the same machine.

7. The computer-implemented system of claim 6, wherein the network-connected client is a personal digital assistant.

8. The computer-implemented system of claim 6, wherein the network-connected client is a wireless device.

9. A computer-implemented system for the dynamic auto-indexing and expansion of the content of an information source based on user-requested content, the system comprising:
a network-connected client having a browser that sends a user request for a content item belonging to a category to the network;
a customization server platform connected to the network, the customization server platform receiving the request for the content item, the server platform comprising:
a first information source having the content item;
an application program specifying a taxonomy of the relationship of content items and actions based on their categories; and
an information retrieval module comprising a front-end application program for retrieving the content item and its linked category content from a second information source on the network and storing the retrieved content in the first information source; and
wherein the network-connected client and the customization server platform are located on the same machine.

10. The computer-implemented system of claim 9, wherein the network-connected client is a personal digital assistant.

11. The computer-implemented system of claim 9, wherein the network-connected client is a wireless device.

12. A computer-implemented system for the dynamic customization of user-requested content, the system comprising:
a network-connected client having a second application program that sends a user request for a content item belonging to a category to the network;
a customization server platform connected to the network, the customization server platform receiving the request for the content item, the server platform comprising:
an information source having the content item;
an application program specifying a taxonomy of the relationship of content items and actions based on their categories; and
a rules and action module having an action belonging to the category and a rule for invoking the action upon the identification of the receipt of a requested content item having the same category as the action; and
wherein the network-connected client and the customization server platform are located on the same machine.

13. The computer-implemented system of claim 12, further comprising a categorizer for identifying the category of the content item and the action, wherein the categorizer and the network-connected client are located on the same machine.

14. The computer-implemented system of claim 12, further comprising a categorizer for identifying the category of the content item and the action, wherein the categorizer is a dedicated hardware device.

15. The computer-implemented system of claim 12, wherein the network-connected client is a personal digital assistant.

16. The computer-implemented system of claim 12, wherein the network-connected client is a wireless device.

17. A computer-implemented system for the dynamic customization of content to a user-specified persona, the system comprising:
a network-connected client having a second application program that sends a user-specified persona belonging to a category to the network;
a customization server platform connected to the network, the customization server platform receiving the persona, the server platform comprising:
an information source for storing the persona;
an application program specifying a taxonomy of the relationship of personas and actions based on their categories; and
a rules and action module having an action belonging to the category and a rule for invoking the action upon the identification of the receipt of a persona having the same category as the action; and
wherein the network-connected client and the customization server platform are located on the same machine.

18. The computer-implemented system of claim 17, wherein the network-connected client is a personal digital assistant.

19. The computer-implemented system of claim 17, wherein the network-connected client is a wireless device.

20. A computer-implemented system for the dynamic customization of user-requested content, the system comprising:
a network-connected subscriber server system having a third application program that forwards a user request for a content item belonging to a category to the network;
a customization server platform connected to the network, the customization server platform receiving the request for the content item, the server platform comprising:
an information source having the content item;
an application program specifying a taxonomy of the relationship of content items and actions based on their categories; and
a rules and action module having an action belonging to the category and a rule for invoking the action upon the identification of the receipt of a requested content item having the same category as the action; and
wherein the network-connected client and the customization server platform are located on the same machine.

21. The computer-implemented system of claim 20, further comprising a categorizer for identifying the category of the content item and the action, wherein the categorizer and the network-connected client are located on the same machine.

22. The computer-implemented system of claim 20, further comprising a categorizer for identifying the category of the content item and the action, wherein the categorizer is a dedicated hardware device.

23. The computer-implemented system of claim 20, wherein the network-connected client is a personal digital assistant.

24. The computer-implemented system of claim 20, wherein the network-connected client is a wireless device.

25. A computer-implemented system for the dynamic auto-updating of the content of an information source based on user-requested content, the system comprising:
a network-connected client having a browser that sends a user request for a content item having a second version indicator, the content item belonging to a category to the network;
a customization server platform connected to the network, the customization server platform receiving the request for the content item having a second version indicator, the server platform comprising:
a first information source having the content item having a first version indicator;
an application program specifying a taxonomy of the relationship of content items and actions based on their categories; and
an information retrieval module comprising:
a back-end application program having a means for comparing the version indicator of a requested content item with the version indicator of the content item stored in the first information source, and sending a request for the URL of the content item when the version indicators do not match; and
a front-end application program for receiving the requested URL from the back-end application program and retrieving the second version content item and its linked category content from a second information source connected to the network and storing the retrieved second version content item and linked category content in the first information source,
wherein the content item having the second version indicator is created subsequent to the creation of content item having the first version indicator; and
wherein the network-connected client and the customization server platform are located on the same machine.

26. The computer-implemented system of claim 25, wherein the network-connected client is a personal digital assistant.

27. The computer-implemented system of claim 25, wherein the network-connected client is a wireless device.

28. A computer-implemented system for the dynamic customization of user-requested content, the system comprising:
a network-connected client having a browser that sends a user request for a content item belonging to a category to the network;
a customization server platform connected to the network, the customization server platform receiving the request for the content item, the server platform comprising:
an information source having the content item;
an application program specifying a taxonomy of the relationship of content items and actions based on their categories; and
a rules and action module having an action belonging to the category and a rule for invoking the action upon the identification of the receipt of a requested content item having the same category as the action; and
a categorizer for identifying the category of the content item and the action, wherein the categorizer and the network-connected client are located on the same machine.

29. The computer-implemented system of claim 28, wherein the categorizer is a dedicated hardware device.

30. The computer-implemented system of claim 28, wherein the network-connected client is a personal digital assistant.

31. The computer-implemented system of claim 28, wherein the network-connected client is a wireless device.

32. A computer-implemented system for the dynamic customization of user-requested content, the system comprising:
a network-connected client having a second application program that sends a user request for a content item belonging to a category to the network;
a customization server platform connected to the network, the customization server platform receiving the request for the content item, the server platform comprising:
an information source having the content item;
an application program specifying a taxonomy of the relationship of content items and actions based on their categories;
a rules and action module having an action belonging to the category and a rule for invoking the action upon the identification of the receipt of a requested content item having the same category as the action; and
a categorizer for identifying the category of the content item and the action, wherein the categorizer and the the network-connected client are located on the same machine.

33. The computer-implemented system of claim 32, wherein the categorizer is a dedicated hardware device.

34. The computer-implemented system of claim 32, wherein the network-connected client is a personal digital assistant.

35. The computer-implemented system of claim 32, wherein the network-connected client is a wireless device.

36. A computer-implemented system for the dynamic customization of user-requested content, the system comprising:
a network-connected subscriber server system having a third application program that forwards a user request for a content item belonging to a category to the network;
a customization server platform connected to the network, the customization server platform receiving the request for the content item, the server platform comprising:
an information source having the content item;
an application program specifying a taxonomy of the relationship of content items and actions based on their categories;
a rules and action module having an action belonging to the category and a rule for invoking the action upon the identification of the receipt of a requested content item having the same category as the action; and
a categorizer for identifying the category of the content item and the action, wherein the categorizer and the network-connected client are located on the same machine.

37. The computer-implemented system of claim 36, wherein the categorizer is a dedicated hardware device.

38. The computer-implemented system of claim 36, wherein the network-connected client is a personal digital assistant.

39. The computer-implemented system of claim 36, wherein the network-connected client is a wireless device.
